(19) United States
(12) Patent Application Publication
(10) Pub. No.: US 2023/0304739 A1
(43) Pub. Date: Sep. 28, 2023

(54) ROTARY BATCH REACTOR VESSEL

(71) Applicant: Sibelco North America Inc., Charlotte, NC (US)

(72) Inventors: Chris Capobianco, Asheville, NC (US); Kelley Davis, Spruce Pine, NC (US); Michael McKinney, Bakersville, NC (US)

(21) Appl. No.: 18/143,245

(22) Filed: May 4, 2023

Related U.S. Application Data
(63) Continuation of application No. 17/221,406, filed on Apr. 2, 2021.
Application No. 17/221,406 is a continuation of application No. 16/854,015, filed on Apr. 21, 2020, now abandoned.
Application No. 16/854,015 is a continuation of application No. 15/918,657, filed on Mar. 12, 2018, now abandoned.
Application No. 15/918,657 is a continuation of application No. 15/210,005, filed on Jul. 14, 2016, now abandoned.
Application No. 15/210,005 is a continuation of application No. 14/168,640, filed on Jan. 30, 2014, now abandoned.
Application No. 14/168,640 is a continuation of application No. 12/931,348, filed on Jan. 28, 2011, now abandoned.
Application No. 12/931,348 is a continuation of application No. 12/413,940, filed on Mar. 30, 2009, now abandoned.
Application No. 12/413,940 is a continuation of application No. 11/264,869, filed on Nov. 2, 2005, now abandoned.
Application No. 11/264,869 is a continuation of application No. 10/838,566, filed on May 4, 2004, now abandoned.

(51) Int. Cl. F27B 7/16

(52) U.S. Cl. CPC F27B 7/161; B01F 29/40221

(57) ABSTRACT

An assembly adapted for incorporation within, and use with, a rotary tubular vessel is disclosed. The assembly includes two oppositely directed finned disks, each defining a central aperture, of a particular size. The assembly includes a collection of longitudinally extending plates that extend between the disks. Upon installation in a tubular vessel, the assembly governs and controls the flow of granular or particulate material through the vessel.

The present invention is a continuation of U.S. patent application Ser. No. 17/221,406, filed Apr. 2, 2021, which is a continuation of U.S. patent application Ser. No. 16/854,015, filed Apr. 21, 2020, which is a continuation of U.S. patent application Ser. No. 15/918,657, filed Mar. 12, 2018, now abandoned, which is a continuation of U.S. patent application Ser. No. 15/210,005, filed Jul. 14, 2016, now abandoned, which in turn is a continuation of U.S. patent application Ser. No. 14/168,640, filed Jan. 30, 2014, now abandoned, which in turn is a continuation of U.S. patent application Ser. No. 12/931,348, filed Jan. 28, 2011, now abandoned, which in turn is a continuation of U.S. patent application Ser. No. 12/413,940, filed Mar. 30, 2009, now abandoned, which in turn is a continuation of U.S. patent application Ser. No. 11/264,869, filed Nov. 2, 2005, now abandoned, which in turn is a continuation of U.S. patent application Ser. No. 10/838,566, filed May 4, 2004, now abandoned, all of which are incorporated by reference into this application.

### FIELD OF THE INVENTION

The present invention relates to a rotary batch reactor vessel, and particularly, to an improved interior configuration for the vessel. Specifically, the present invention relates to an aperture assembly for use in rotary tube reactors to allow control of movement of particulate material through the system.

### BACKGROUND OF THE INVENTION

Rotary tube furnaces are typically used to process granular powder continuously at high temperature. The tube is rotated and serves two purposes. First, the rotation overcomes the grain's angle of repose and thereby produces gravity flow through the tube. And, second, rotation facilitates gas-to-grain contact by the overturning action it provides. When process gases are used in conjunction with rotary tube reactors, the tube is usually modified with apertures to control gas flow and grain movement.

An example of an apertured component that has proved successful to restrict ambient atmosphere from certain regions within the tube, e.g. a reaction zone, is known as a turbo disk. A turbo disk has several features as follows. First, process gas is introduced into the reaction zone of the tube through a small axial hole in the disk that is just large enough to accept a gas injector tube. The small amount of open area in the disk produces the desired restriction in gas flow. In order to enable processed grain to pass from the reaction zone to the exit side of the disk, openings are provided along the circumference of the disk. These openings are fashioned from radial slits separated by ninety degrees from one another. The region of the disk adjacent to the slit is bent out of the plane of the disk to create a triangularly shaped flap. The arc of the flap is welded to the inside of the tube and the opening thereby created has little or no straight-through area on the plate. In this arrangement, when the tube is rotated in the correct direction, each of these flaps act like a partial screw and causes a portion of the grain bed to advance to the other side of the disk and thereby discharge from the reaction zone. The steady state retention time in the reaction zone of a tube with a turbo disk depends on the rotation rate, tube angle and size of the flap opening.

Although satisfactory in many respects, a need exists for an improved interior configuration for a tubular vessel, and for a component to be incorporated therein, that governs and more accurately controls flow of granular or particulate material through a rotary tube vessel.

### SUMMARY OF THE INVENTION

In a first aspect, the present invention provides an aperture assembly adapted for incorporation in a tubular vessel. The assembly comprises a first disk defining a first collection of finned apertures defined about the outer periphery of the first disk. The assembly also comprises a second disk defining a second collection of finned apertures defined about the outer periphery of the second disk. The assembly additionally comprises at least one longitudinal planar member extending between and adjoined to both the first disk and the second disk.

In another aspect, the present invention provides an aperture assembly adapted for use in a tubular vessel. The assembly comprises a first disk defining a first central opening and a first set of finned apertures defined about the outer periphery of the first disk. The assembly also comprises a second disk defining a second central opening and a second set of finned apertures defined about the outer periphery of the second disk. The assembly further comprises at least one longitudinal planar member extending between and adjoined to both the first disk and the second disk. In the noted assembly, the first set of finned apertures project away from the second disk and the second set of finned apertures project away from the first disk.

In another aspect, the present invention provides a tubular vessel comprising a cylindrical body defining a first end, a second end opposite from the first end, and a hollow interior extending between the first end and the second end. The vessel also comprises an aperture assembly which is disposed within the hollow interior of the body. The aperture assembly includes a first disk that defines a plurality of finned apertures positioned along the circumference of the first disk. The aperture assembly also includes a second disk defining a plurality of finned apertures positioned along the circumference of the second disk. The aperture assembly also includes a plurality of longitudinal members extending between the first and second disks.

In yet another aspect, the present invention provides a method for selectively controlling the flow of particulate material through a rotatable tubular vessel. The method comprises steps of providing the vessel and an aperture assembly. The aperture assembly includes a first disk that defines a plurality of finned apertures defined about the periphery of the disk. The assembly also includes a second disk that defines a plurality of finned apertures defined about the periphery of the second disk. The assembly further includes a plurality of longitudinal members extending between the first and second disks. The method also comprises a step of securing the aperture assembly within the vessel. And, the method comprises a step of selectively rotating the vessel and the aperture assembly secured therein. Rotation in a first direction promotes flow of the particulate material through the vessel. And, rotation in an opposite direction halts the flow of material through the vessel.

### BRIEF DESCRIPTION OF THE DRAWINGS

The present invention may take form in various components and arrangements of components, and in various techniques, methods, or procedures and arrangements of steps. The referenced drawings are only for purposes of illustrating preferred embodiments, they are not necessarily to scale, and are not to be construed as limiting the present invention.

FIG. 1 is a perspective view of a preferred embodiment aperture assembly in accordance with the present invention.

FIG. 2 is an end view of the preferred embodiment assembly depicted in FIG. 1.

FIG. 3 is a side elevational view of the preferred embodiment assembly depicted in Figure, taken along line III-III.

FIG. 4 is a partial cross-sectional side view of the preferred embodiment assembly incorporated in a tubular vessel in accordance with the present invention.

FIG. 5 is a partial fragmentary perspective view of the preferred embodiment assembly and vessel depicted in FIG. 4.

### DETAILED DESCRIPTION OF THE PREFERRED EMBODIMENTS

In accordance with the present invention, an aperture assembly is provided that is particularly adapted for use with, and incorporation within, a rotary tubular vessel. A preferred embodiment of the assembly includes two circular disks with finned apertures that are spaced from and joined to one another by a plurality of longitudinal planar members. Each of the disks defines a central opening or aperture. And, each of the disks defines a plurality of fins along the periphery that project at an inclination to the surface of the disk. Preferably, both disks have the same “handedness,” which is defined by the configuration of the inclined fin projections. This aspect is described in greater detail herein. The number of finned apertures per disk may vary, but is preferably from about 2 to about 6, with 4 being most preferred. Additionally, it is preferred that regardless of the number of finned apertures provided on each disk, that the finned apertures be equidistant or evenly spaced from one another along the circumference of each disk. For example, if 4 finned apertures are provided on a disk, it is preferred that the finned apertures be separated from one another by 90°.

The number of longitudinal planar members extending between the two disks preferably corresponds to the number of finned apertures defined on each disk. For example, if each disk is provided with 4 finned apertures, then the preferred number of longitudinal members is 4.

As noted, each disk preferably defines a circular opening or aperture at its center. Although the preferred shape for the opening is a circle, other shapes may be utilized such as, but not limited to, oval, elliptical, square, rectangular, triangular, hexagonal, polygonal, and others. Preferably, the sizes of the openings defined in the two disks are different from one another. For circular openings, it is preferred that the ratio of diameters of the circular openings defined in the two disks of a preferred assembly be in the range of from about 0.25:1 to about 1.25:1, with the most preferred ratio being 0.75:1. An example of a preferred aperture assembly with this most preferred ratio utilizes a first disk having a center opening with a diameter of 0.75 inches, and a second disk with a center opening having an aperture of 1.0 inches. This exemplary aperture assembly utilizes disks each having diameters of about 8.8 inches. It will be appreciated that the present invention assemblies include disks having outer diameters greater than or less than this size. The present invention aperture assembly also includes the use of apertures or openings in the disks having dimensions greater than or lesser than these values, or ratios. Moreover, it will be understood that the present invention assemblies do not require the use of the central openings defined in the disks. Central openings are needed only when process gasses are to be injected into the reaction zone. The central openings are not a necessary part of the invention. The larger size of the opening closest to the end is to allow clearance for a smaller tube, i.e., an injection tube, which is stationary with respect to the rotating tube. The central opening closest to the reaction zone can be smaller because the position of the injection tube tip can be positioned to fit inside.

Whereas it is preferred that the disks be of the same handedness, it is also preferred that the disks be oriented in the preferred aperture assembly so that each fin or set of fins projects away from the space defined between the two disks. This aspect is also described in greater detail herein.

The present invention aperture assembly is preferably utilized in conjunction with a rotary tubular reactor. Such reactors are generally long, cylindrical vessels within which various processing operations or reactions can be conducted. Typically, such tubular vessels are rotated during operation and may be oriented such that one end of the vessel is positioned higher than the opposite end. The end that is elevated is generally designated as the feed end. The other, opposite end is generally designated as the discharge end.

The preferred embodiment aperture assembly is particularly well suited for use with rotary tubular reactors. Generally, the assembly is incorporated within the interior of the tubular vessel, and most preferably mounted or otherwise secured within the interior of the vessel. Upon rotation of the vessel, the aperture assembly also rotates.

In applications in which a powdered, granular, particulate or comminuted solid material is fed to or through a tubular reactor or vessel utilizing the present invention aperture assembly, the assembly permits flow of material through it, and thus, through the vessel, during rotation of the vessel in one direction. The present invention aperture assembly prevents flow of material through it and the vessel upon the vessel undergoing rotation in the opposite direction.

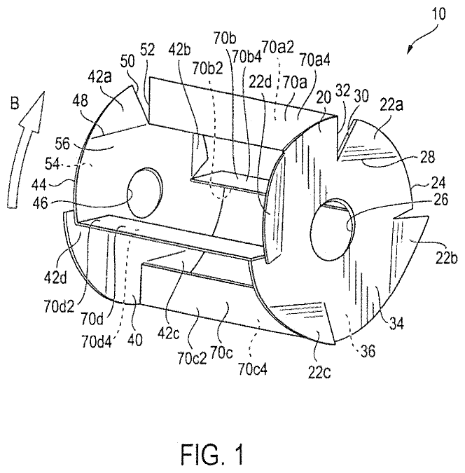

The preferred embodiments will now be described with reference to FIGS. 1-5. Referring to FIG. 1, a preferred embodiment aperture assembly 10 is illustrated. The aperture assembly 10 comprises a first end disk 20 and a second, opposite, second end disk 40. Each of the disks 20 and 40 are separated and adjoined to one another by a collection of longitudinal plates 70. These are identified in FIG. 1 as plates 70a, 70b, 70c, and 70d. The first end disk includes a plurality of fins 22. Specifically, the first end disk 20 includes a finned aperture 22a, a finned aperture 22b, a finned aperture 22c, and a finned aperture 22d. The first end disk 20 includes a circumferential edge 24 and defines a centrally disposed aperture 26. Each of the finned apertures 22a, 22b, 22c and 22d are formed preferably by defining a radial slit from a first edge 30 and a second opposing edge 32. A bend line 28 is defined and the finned aperture is formed by projecting the fin away from the plane of the disk 20.

The second end disk 40 includes a plurality of finned apertures such as 42a, 42b, 42c and 42d. The second end disk 40 includes a circumferential edge 44. And, the second end disk defines a centrally disposed aperture 46. In the aperture assembly 10 described herein, the aperture 46 of the second disk 40 is preferably smaller than the aperture 26 defined in the first disk 20. The relative sizes of the apertures are preferably as previously described herein. Each of the finned apertures 42a, 42b, 42c and 42d are formed preferably by defining a bend line 48 and bending or otherwise projecting the fin 42 outward from the plane of the disk 40. The finned aperture 42 is formed by defining first and second edges 50 and 52, respectively, such as shown in FIG. 1. The second end disk 40 includes an outer face 54 and an oppositely directly inner face 56.

Each of the disks 20 and 40 are separated from one another and secured to one another by at least two longitudinal plates 70. In the preferred embodiment illustrated in FIG. 1, the aperture assembly 10 comprises longitudinal plates 70a, 70b, 70c and 70d. As previously explained, the number of longitudinal plates 70 preferably corresponds to the number of finned apertures 22 and 42 provided on each of the first and second disks 20 and 40, respectively.

The longitudinal members that connect the first disk, 20, to the second disk, 40 define the location of the finned apertures. Specifically, each longitudinal member defines two sides, labeled, e.g., 70b2 and 70b4. The finned apertures, 22a, 22b, 22c, and 22d, of the first disk, 20, adjoin to the sides of longitudinal members 70a2, 70b2, 70c2, and 70d2, respectively. Whereas, the finned apertures, 42a, 42b, 42c, and 42d, of the second disk, 40, adjoin to the sides of longitudinal members 70a4, 70b4, 70c4, and 70d4. For example, the longitudinal member 70a defines a first side 70a2 and a second side 70a4, opposite from the first side 70a2. The longitudinal member 70a is preferably disposed relative to the finned apertures of disks 20 and 40 such that the first side 70a2 of the member 70a adjoins a finned aperture 22a of the disk 20 and the second side 70a4 adjoins a finned aperture 42a of the second disk, the finned aperture 42a being positioned generally opposite from the finned aperture 22a. The first end disk 20 defines an outer face 34 and an oppositely directed inner face 36.

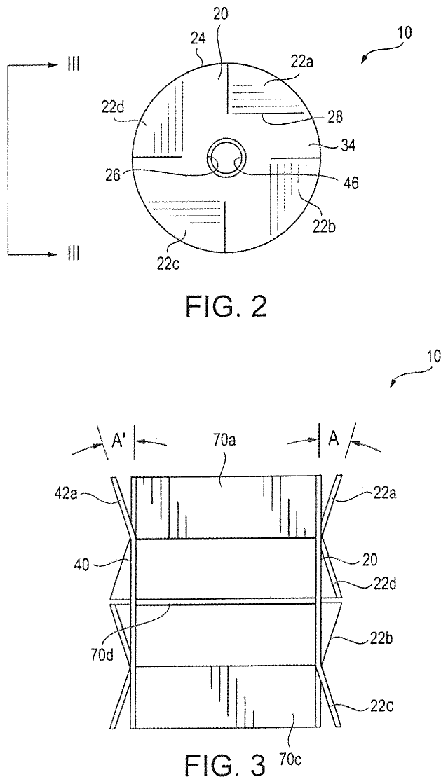

FIG. 2 illustrates an end view of the aperture assembly 10 illustrating a preferred configuration for the first end disk 20. Each of the finned apertures 22a, 22b, 22c and 22d are illustrated and the centrally disposed aperture 26 as also shown.

FIG. 3 is a side view of the preferred embodiment aperture assembly 10, taken along line III-III shown in FIG. 2. There, it can be seen that the assembly includes the first and second end disks 20 and 40 which are separated by a plurality of longitudinal plates 70, e.g. plates 70a, 70b (not shown), 70c, and 70d. FIG. 3 also illustrates a preferred aspect in which the fins project outward from each respective disk 20 or 40 by an angle of A or A′, respectively. Specifically, the fin 22a projects outward from the first disk 20 by an angle of A. And the fin 42a and other fins, of the second disk 40, project outward from the second disk by an angle A′. It is preferred that each fin 22 of the first disk 20 project outward from the plane of the disk, by the same angle. Restated, it is preferred that angle A be the same for all fins of the disk 20. Similarly, it is preferred that each fin 42 of the second disk 40 project outward by the same angle, i.e. angle A′. However, the present invention includes embodiments in which the angle of projection of fins on a disk varies between fins. It is also preferred that the angles of projection associated with each disk be the same, i.e. A equals A′. However, the present invention includes embodiments in which the angle A of disk 20 is different than the angle A′ of disk 40. Generally, the angles A and A′ are from about 5° to about 30°, and more preferably from about 10° to about 20°. However, the present invention includes assemblies utilizing greater or lesser angles.

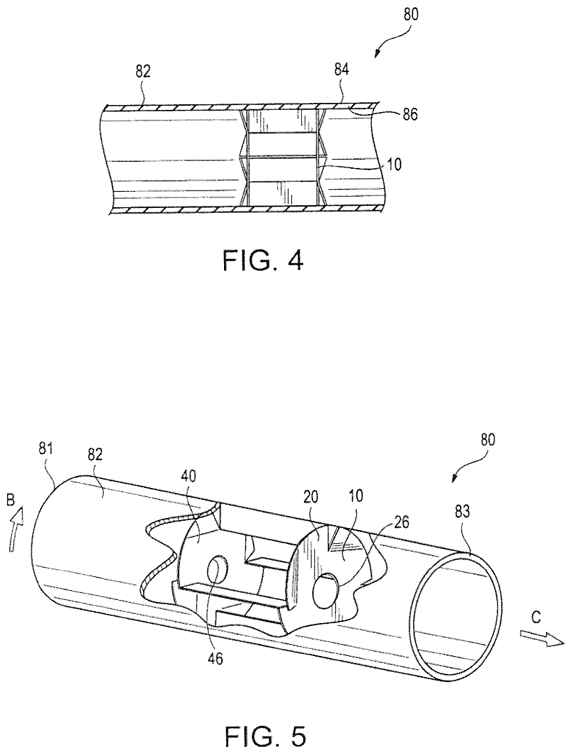

FIGS. 4 and 5 illustrate a preferred embodiment vessel and aperture assembly 80 in accordance with the present invention. The assembly 80 includes an aperture assembly such as previously described aperture assembly 10 that is installed or otherwise incorporated within a tubular vessel 82. The tubular vessel 82 includes a vessel wall defining an outer face 84 and an inner face 86. The preferred embodiment aperture assembly 10 preferably contacts and is secured to the inner vessel face 86.

FIG. 5 is a partial fragmentary view showing the positioning of the preferred embodiment aperture assembly 10 within the tubular vessel 82. It is important to note that the preferred orientation of the aperture assembly 10 with respect to the tubular vessel 82 is such that flow of material within the tubular vessel, as indicated by arrow C, preferably is directed toward the second disk 40 having the smaller aperture, i.e. aperture 46. That is, the aperture assembly 10 is positioned within the tubular vessel 82 such that the second disk 40 receives the flowing material from the feed end of the rotary or tubular vessel 82.

As previously noted, it is preferred that the aperture assembly provides apertures defined in the two end disks that are of different sizes, and preferably within a ratio from about 0.25:1 to about 1.25:1, with the most preferred ratio being 0.75:1. In accordance with another aspect of the invention, it is preferred that the assembly be incorporated within the vessel or reactor so that its disk having the smaller opening is directed to a feed end 81 of the vessel, and the disk having the larger opening is directed to a discharge end 83 of the vessel. Referring further to FIG. 5, where the direction of material flow is shown by arrow C, the aperture 46 defined in disk 40 preferably is of a smaller size than the aperture 26 defined in disk 20. Most preferably, the ratio of diameters of aperture 46 to that of aperture 26 is 0.75:1. Upon rotation of the assembly 80 in the direction of arrow B, feed material is conveyed or otherwise displaced from the feed end 81, through the aperture assembly 10, and toward the discharge end 83 of the vessel 82. Upon rotation of the assembly in the direction opposite from the direction of arrow B, flow or transport of feed material is halted. Thus upon halting the flow of material, the residence time of that material within the vessel may be selectively increased.

A representative application of the preferred embodiment aperture assembly is in a drying or roasting application of grain within a rotary tubular vessel. In such an application, the aperture assembly is mounted such as by welding or otherwise installed within the interior of a tubular vessel. This enables the processing of grain in a rotary tube reactor for an indefinite retention time and independently of the tube's rotation rate. Use of the preferred embodiment assembly prevents the grain bed from advancing. Instead, the direction of tube rotation controls the flow of grain or the grain bed through the tube. If the tube is rotated one way, the grain backfeeds continuously into the reaction zone. But, reversing the direction of rotation allows the bed to discharge completely and efficiently from the vessel. Thus a batch of grain can be processed for an optimal retention time and with continuous overturning before being discharged in a conventional rotary tube reactor.

In a preferred embodiment of the aperture assembly, both disks have the same configuration, i.e., the fins are formed by projection from symmetrically equivalent positions with respect to the radial slits, and this gives them the same handedness. However, the disks are positioned opposite from one another so that the fins of one disk project away from those of the other. Additionally, to create the maximum rotational offset of finned apertures within the sectors created by the longitudinal plates, the disks are rotated with respect to each other. The longitudinal planar members are mounted against the flat side of the disk openings and provide the means by which grain backfeeds into the reaction zone through the finned apertures of the upstream disk. When rotated for discharge, grain exits through the downstream finned aperture.

The processing advantage of the preferred embodiment assembly permits arbitrarily long retention times with continuous bed overturn, but without complications associated with loading and unloading that would arise if a sealed tube or vessel were employed.

Although the present invention and its preferred embodiments have been described as utilizing circular disks, the invention includes the use of end components having shapes or perimeter configurations that are non-circular. Generally, the preferred embodiment assembly uses circular-shape disks due to the interior of most tubular vessels being cylindrical in shape. However, if the interior configuration of a vessel exhibited a square cross section, in accordance with the present invention, an aperture assembly utilizing square-shape end components could be used.

The present invention aperture assembly may be formed from nearly any material that is sufficiently rigid and resistant to the conditions in which the assembly will be used. Examples of such materials include, but are not limited to, steel and alloys thereof including stainless steel, glass, and composite materials.

It is also contemplated that instead of utilizing a separate aperture assembly that is subsequently installed or otherwise incorporated within a vessel, that the components may be formed together, and in certain applications, integrally with one another. That is, the present invention includes embodiments in which a vessel is provided with an interior configuration corresponding to the aperture assembly described herein.

The foregoing description is, at present, considered to be the preferred embodiments of the present invention. However, it is contemplated that various changes and modifications apparent to those skilled in the art may be made without departing from the present invention. Therefore, the foregoing description is intended to cover all such changes and modifications encompassed within the spirit and scope of the present invention, including all equivalent aspects.

1-25. (canceled)

26. A method for selectively controlling flow of particulate material through a rotatable tubular vessel having a feed end, a discharge end, and defining a hollow interior extending between said feed end and said discharge end, said method comprising:
providing an aperture assembly including a first disk and a second disk, said first disk having a first plurality of finned apertures defined about a periphery of said first disk, said second disk having a second plurality of finned apertures defined about a periphery of said second disk, said aperture assembly further including a plurality of longitudinal members extending between said first disk and said second disk;
securing said aperture assembly within said hollow interior of a tubular vessel; and
selectively rotating said tubular vessel and said aperture assembly secured therein, whereby rotation in a first direction promotes flow of said particulate material through said vessel, and rotation in a second direction opposite from said first direction, halts flow of said particulate material through said vessel.

27. A rotary batch reactor vessel comprising: a cylindrical body having a first end and a second end extending along a body axis between said first and second ends, said body having in inner surface that defines an axially extending hollow interior extending between said first end and said second end; said vessel further including an aperture assembly positioned within said hollow interior and spaced from said first and second ends, said aperture assembly having a first disk and an axially spaced second disk joined to said first disk by a plurality of axially extending members, said first disk including a first plurality of fins extending outwardly toward said first end and said second disk including a second plurality of fins extending outwardly toward said second end.

28. The rotary batch vessel of claim 26 wherein said first end of said body is the feed end and said aperture assembly is disposed within said hollow interior of said body such that said second disk of said assembly is directed toward said feed end of said body.

29. The rotary batch vessel of claim 28 wherein said first disk further includes a first outer circumferential edge and a first opening spaced from said first circumferential edge, said second disk including a second outer circumferential edge and a second opening spaced from said second circumferential edge, said first plurality of fins being adjacent to said first circumferential edge and said second plurality of fins being adjacent to second circumferential edge.

30. The rotary batch vessel of claim 26 wherein said first disk further includes a first outer circumferential edge and a first opening spaced from said first circumferential edge, said second disk including a second outer circumferential edge and a second opening spaced from said second circumferential edge, said first plurality of fins being adjacent to said first circumferential edge and said second plurality of fins being adjacent to second circumferential edge.

31. The rotary batch vessel of claim 27 wherein said first plurality of fins is at least 3 fins.

32. The aperture assembly of claim 27 wherein said plurality of axially extending members each are joined to said first and second disks near one of said first and second plurality of fins.

33. An aperture assembly for a rotary batch vessel, said aperture assembly comprising a first disk and a second disk, said first disk having a first plurality of finned apertures spaced about a first outer periphery of said first disk; said second disk having a second plurality of finned apertures defined about a second outer periphery of said second disk; said aperture assembly further including a longitudinal member fixed relative to said first disk and said second disk.

34. The aperture assembly of claim 33 wherein said first plurality of finned apertures project away from said second disk.

35. The aperture assembly of claim 34 wherein said second plurality of finned apertures project away from said first disk.

36. The aperture assembly of claim 33 wherein said second plurality of finned apertures project away from said first disk.

37. The aperture assembly of claim 33 wherein each of said finned apertures of said first plurality of finned apertures projects outward wherein said aperture angle is about 5° to about 30°.

38. The aperture assembly of claim 33 wherein said at least one longitudinal member is at least one planar member, said first plurality of finned apertures includes a first finned aperture adjoining one of said at least one planar member.

39. The aperture assembly of claim 38 wherein said second plurality of finned apertures includes a second finned aperture disposed generally opposite from said first finned aperture, said second finned aperture adjoining said one longitudinal member.

40. The aperture assembly of claim 33 wherein said first disk further defines a first central opening, said second disk further defines a second central opening, and said first opening being larger than said second opening.

41. The aperture assembly of claim 33 wherein said first plurality of finned apertures project away from said second disk, and said second plurality of finned apertures project away from said first disk.

42. The aperture assembly of claim 33 wherein the number of finned apertures of said first plurality ranges from 2 to 6.

43. The aperture assembly of claim 33 wherein said first disk further defines a first central opening, said second disk further defines a second central opening, said first and second openings are both circular, and said first opening is larger than said second opening.
